(19) United States
(12) Patent Application Publication
(10) Pub. No.: US 2005/0256911 A1
(43) Pub. Date: Nov. 17, 2005

(54) Method and system for detecting proximate data

(76) Inventors: Gavin Peacock, Hampshire (GB); George Bolt, Hampshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/073,358

(22) Filed: Mar. 4, 2005

Related U.S. Application Data
(63) Continuation of application No. PCT/AU03/01145, filed on Sep. 4, 2003.

(30) Foreign Application Priority Data
Sep. 4, 2002 (GB) 0220576.3

(51) Int. Cl. G06F 12/00

(52) U.S. Cl. 707/200

(57) ABSTRACT

In one embodiment, a data proximity detector comprises a storage device, a processor and an alert generator. A database of records known to satisfy a condition is stored in the storage device. The processor checks a new record against each record retrieved from the database for a close match. In the event that a close match is found the alert generator creates an alert indicating an inference that the new record also satisfies the condition.

### RELATED APPLICATIONS

This application is a continuation application, and claims the benefit under 35 U.S.C. §§ 120 and 365 of PCT Application No. PCT/AU2003/001145, filed on Sep. 4, 2003 and published Mar. 18, 2004, in English, which is hereby incorporated by reference.

### BACKGROUND OF INVENTION

1. Field of the Invention

The present invention relates to a method of detecting proximate data and a data proximity detector for applying the method.

2. Description of the Related Technology

In instances where a person establishes a service with an intention to commit fraud, the person has often been involved in a similar fraud before or is using a technique similar to known instances of fraud. In the establishment of a new service (such as a new mobile phone account) a new record is created with details provided by the fraudster. The details in the record are often deliberately incorrect (such as including a non-existent address). The definition of what record and field values indicate fraud depends on the particulars of the industry, policy and circumstance. However, a good example of fraud would be making an application for a service without intent to pay for the continued running of that service, possibly by disguising the applicant's identity.

When a new record arrives, the potential for fraud is normally only recognised by the service provider if the details provided match (exactly) previous fraud related records, for example if a fraudster uses the same address then this can be flagged. However fraudsters usually don't use the same address. In particular, with service applications where the fraudulent applicant alters parts of the application in an attempt to subvert any anti-fraud checking the likelihood of detection is small. For example, altering the address so that a simple mechanised check would fail to match the addresses, but the change from a previous fraudulent address may be small enough that a postman would treat both as the same.

### SUMMARY OF CERTAIN INVENTIVE ASPECTS OF THE INVENTION

One aspect of the present invention seeks to address this shortcoming by detecting data similar (proximate) to existing cases of fraud.

Another aspect of the present invention provides a method of detecting proximate data for use in fraud detection comprising: providing a database of records known to be fraudulent; and checking a new record against each record in the database for a close match and in the event that a close match is found inferring that the new record is fraudulent.

Preferably the process of checking whether the new record is a close match comprises applying a matching algorithm to the new record and each record of the database to generate a probability of a match.

Preferably in the event that the probability exceeds a threshold then there is deemed to be a close match. Preferably the probability is generated using field specific comparisons. Alternatively the probability is generated using aggregating comparisons. Preferably the probability is generated using a combination of field specific comparisons and aggregating comparisons.

Another aspect of the present invention provides a data proximity detector comprising: a storage device for storing a database of records known to be fraudulent; a processor for checking a new record against each record in the database for a close match; and an alert generator for indicating an inference that the new record is fraudulent in the event that the processor determines there to be a close match.

Still another aspect of the present invention provides a method of detecting proximate data comprising: providing a database of records known to satisfy a condition; and checking a new record against each record in the database for a close match and in the event that a close match is found inferring that the new record also satisfied the condition.

Yet another aspect of the present invention provides a data proximity detector comprising: a storage device for storing a database of records known to satisfy a condition; a processor for checking a new record against each record in the database retrieved from the storage device for a close match; and an alert generator for indicating an inference that the new record also satisfies the condition in the event that the processor determines there to be a close match.

### BRIEF DESCRIPTION OF THE DRAWINGS

In order to provide a better understanding, preferred embodiments of the present invention will be described, by way of example only, with reference to the accompanying drawings, in which:

FIG. 1 is an example class diagram showing the relationship between objects of the data proximity detector;

FIG. 2 is a flow chart showing steps according to one embodiment of the present invention;

FIG. 3 is an example tree diagram representing an aggregating algorithm for combining subsidiary matching algorithms according to one embodiment of the present invention; and

FIG. 4 is a schematic block diagram representing a preferred form of a data proximity detector according to one embodiment the present invention.

### DETAILED DESCRIPTION OF CERTAIN EMBODIMENTS OF THE INVENTION

In one embodiment, the data proximity detector may form one part in the array of fraud detection components used by a fraud detection system which automatically analyses a continuous list of records for fraudulent behaviour. These records may constitute call data records, service applications (for example applications for a mobile phone) or other such communications of known format.

As shown in FIG. 4, a preferred form of the data proximity detector (DPD) 30 of the present invention may be in the form of a computer configured to run a computer program for controlling the computer such that it performs the method of the present invention. The DPD is provided with a database of records known to be fraudulent, which are stored in a storage means 36 (such as a hard disk drive of the computer). The DPD receives new records from input 32, which are to be checked for possible fraud. A processor 34 of the DPD performs the check according to the method described below. If the check results in a positive inference of fraud, the computer operates as an alert generator (by providing an appropriate signal to an output 40 from input/output device 38) to provide an indication of the inferred fraud.

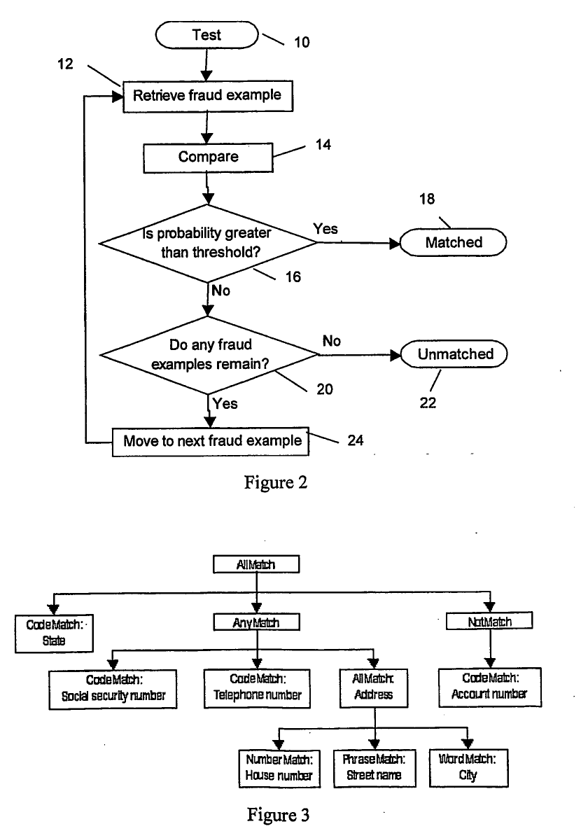

The DPD matching procedure is described by the flow diagram of FIG. 2. Each new record is tested at step 10. An entry in the database is retrieved 12. The new data and the retrieved record are compared at 14 where a probability of a match is calculated. This probability is then compared to a threshold at 16. If the probability is greater than the threshold then the new record is considered to be matched at 18 and an alert generated. If the probability is less than or equal to the threshold the processor then checks whether all of the records in the database have been checked at 20. If there are no remaining records then the new data is considered unmatched at 22. If there is a record remaining 24 the process then returns to step 12 where the next record is retrieved and compared. Checking continues until all records of the fraud database have been searched.

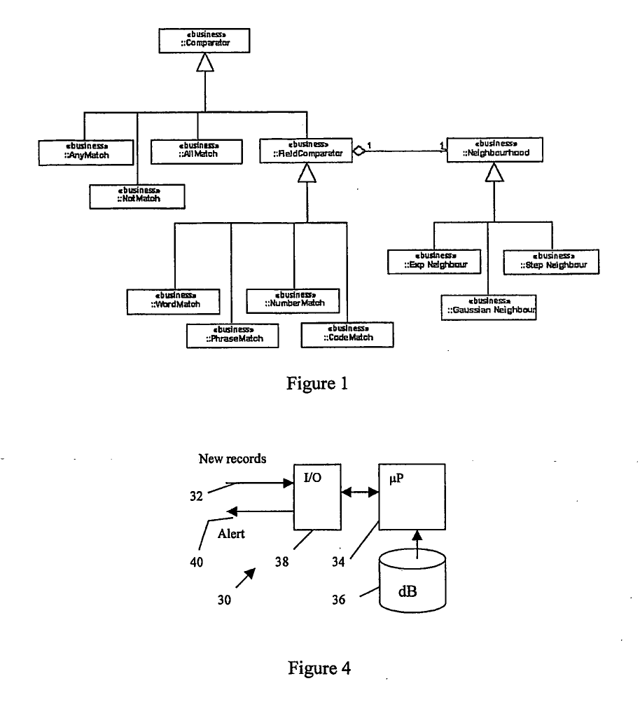

The DPD matching algorithm is designed to be highly configurable. The high level of configuration is provided to enable the DPD to cope with a wide variety of data sources that it may have to handle. To do this, the DPD match algorithm is constructed dynamically as guided by a configuration, out of several simple, small matching algorithms that can be plugged together. To get these constituent matching algorithms to plug into each other, all matching algorithms conform to a matching algorithm prototype. FIG. 1 shows example algorithms that conform to this standard and the relationships between them. FIG. 1 is a class diagram in accordance with the UML (Unified Modelling Language) standard. The constituent matching algorithms are grouped into two broad categories of matching tasks: field-specific comparisons; and aggregating comparisons.

The field-specific matching algorithms share a common prototype derived from the matching algorithm prototype. Each field match is dedicated to a single field of the two records being compared. The field-match creates an information-based distance measure to indicate how much of a change would be required to convert the value found in one record into the value found in the other record. A simple transformation referred to as the neighbourhood function converts this distance into a probability for use by other matching algorithms. Typical types of field matching are: number match; code match; word match; and phrase match. The distance measures of these field-matching algorithms are described below.
The number match treats the contents of the field as a number and returns the absolute numeric difference between field values.
The code match returns the number of characters in the two values that do not match, often called the Hamming distance. The characters involved can be of any type so long as they do not have a meaningful ordering. An example of a field suitable for code matching would be telephone number. Where two code fields are of different lengths, the extra characters of the longer code add to the distance between the two fields.

Word matches return the minimum number of character operations required to convert one field into the other. The operations used are shown in the table below.

Table of Character Operations

| Operation | Example |
|---|---|
| Insertion | bat □ bait |
| Deletion | bait □ bat |
| Substitution | bat □ bit |
| Exchange | bait □ biat |
| Duplication | batle □ battle |
| Deletion of duplicate | battle □ batle |

The operations: repetition and deletion of repetition are given lighter weighting so that a smaller distance is incurred. The word-matching algorithm will not search beyond a maximum distance as defined by a preset threshold on the resulting probability.
Phrase matches return the minimum number of weighted word operations required to change one field into the other. The phrase match algorithm uses the same matching algorithm as the word match algorithm except that word operations are substituted for character operations. The distances of the word operations: substitute and exchange are given by the word-matching algorithm. The distances for the insert and delete operations are simply the length of the inserted or deleted word. The distances of the repeat and delete repetition operations are scaled down versions of the insert and delete distances. In addition, a dictionary of abbreviations may be supplied. Where a whole word precisely matches an abbreviation in the abbreviation dictionary, that word will be substituted with the word associated with that abbreviation. As with the word-matching algorithm, the phrase-matching algorithm will not search beyond a maximum distance as defined by a preset threshold on the resulting probability.

Any field match may be given a list of exceptions that will fail the match if the field value of either record is exactly set to one of those exceptions.

The standard neighbourhood function is the exponential neighbourhood, and this is used to treat the distance measure as an information measure. A Gaussian neighbourhood is provided, and this is equivalent to the exponential neighbourhood where the distance measure is squared first. The step neighbourhood generates probabilities of 100% if the distance is within a predefined proximity, but 0% otherwise. The full definitions of these functions are given in the table below.

| Neighbourhood | Definition |
|---|---|
| Exponential | y = exp(− x/x₀) |
| Gaussian | $y = exp ( - {( \frac{x}{{x}_{0}} )}^{2} )$ |
| Step | $y = \{ \begin{matrix}1 if x \leq {x}_{0} \\ 0 if x > {x}_{0}\end{matrix}$ |

Table of Neighbourhood Functions

The inputs x are the distances generated by the field-specific matching algorithms.
The constants x₀ are ‘proximity’ values that control the range over which the neighbourhood operates.

The aggregating matching algorithms modify and combine the results from one or more child matching algorithms. They are used to combine the many probabilities generated for each field of the records by the field-specific comparisons into a single probability for the whole record. The result is a tree structure with a single probability for the whole record at its root, an aggregating matching algorithm at each branch, and a field-specific matching algorithm at each leaf. For an example, see FIG. 3. The construction of the tree is declared in the configuration. This configuration first defines which aggregating matching algorithm to use, and then which matching algorithms belong to it. The format and syntax of the configuration is irrelevant provided that it can express a tree structure and the various match-specific properties.

The not match algorithm owns a single matching algorithm of any of the given types. The probability returned by the not operator is one-minus the probability of its child matching algorithm.

The all match algorithm owns a list of matching algorithms of any of the given types. The all match returns the probability that all of its child matches detect a match. If at any point during this calculation, the combined probability drops below a preset threshold, then the match is deemed as failed, and the operation does not consult its child matching algorithms further.

The any match algorithm owns a list of matching algorithms of any of the given types. The any match returns the probability that any of its child matches detect a match. If at any point during this calculation, the result exceeds the preset threshold, then the match is deemed made, and the algorithm does not consult its child matching algorithms further.

Both the ‘all’ and the ‘any’ algorithms support an inference mechanism that can be used to capture dependencies between fields. For example, the discovery of a match between address fields makes a match between name fields more likely. This makes the combination of both name and address less significant. This combines with the above descriptions of the all and any matches to give the full definitions:

$$all ( {p}_{1} , {p}_{2} , … {p}_{n} ) = {\prod }_{i} ( 1 - ( 1 - {p}_{i} ) {\prod }_{j} ( 1 - {p}_{j} {r}_{ij} ) ) , \\ any ( {p}_{1 ,} {p}_{2} , … {p}_{n} ) = 1 - {\prod }_{i} ( 1 - {p}_{i} {\prod }_{j} ( 1 - ( 1 - {p}_{j} ) ( 1 - {r}_{ij} ) ) ) ,$$

where n is the number of children, the rᵢⱼ coefficients give the inference that can be made from pⱼ on pᵢ, where i indexes the child algorithms for their direct contribution, and j indexes the child algorithms for the inference on the child i. The rᵢⱼ coefficients are set to give the actual probability of a match given that there is no match. For example, if addresses match, but we take it as given that names do not match, the matching algorithm assigned to the name field will on average give a significant non-zero probability because family members will share surnames. The r_{name,address} coefficient will be set to this probability.
   Worked Examples
   Number Matches

Given the two records with the house number fields:
20
21
   a numeric match with a proximity of 2 and an exponential neighbourhood, will generate a probability of:
   exp(−|21−20|/2)=exp(−0.5)=61%
   Code Matches

Given the two records with the telephone number fields:
7821865874
7821868574
   a number match with a proximity of 1 and an exponential neighbourhood, the distance is 2.0 (two digits had to be changed) giving a probability of:
   exp(−2/1)=14%
   Word Matches

Given the two records with the town fields:
Petersfield
Petterfeild

a word match with a proximity of 6 and an exponential neighbourhood, the distance is given as the sum of the contributions from the character operations required to transform one into the other:

Examples of Transformations of Words

| Word | Operation | Contribution |
|---|---|---|
| Petersfield | — | — |
| Pettersfield | Duplication | 0.5 |
| Petterfield | Deletion | 1.0 |
| Petterfeild | Exchange | 1.0 |

This totals to 2.5 giving a probability of:
exp(−2.5/6)=66%
Phrase Matches

Given the two records with the road fields:
Saint Gerassimo Road
St. Grasimo Rd

a phrase match with a proximity of 10, an exponential neighbourhood, and an abbreviation dictionary that includes abbreviations for Saint and Road then the distance is given as the sum of the contribution from the word operations required to transform one into the other:

Examples of Transformations of Phrases

| Phrase | Operation | Contribution |
|---|---|---|
| Saint Gerassimo Road | — | — |
| St. Gerassimo Road | Abbreviation | 0.0 |
| St. Grasimo Rd | Word substitution | 1.5 |
| St. Grasimo Rd | Abbreviation | 0.0 |

This totals to 1.5 giving a probability of:
exp(−1.5/10)=86%
All Matches

Given the two records:
20, Saint Gerassimo Road, Petersfield, 7821865874
21, St. Grasimo Rd, Petterfeild, 7821868574
   an all match without inferences will combine the results from the previous examples to give:
   61%×86%×66%×14%=5%
   Any Matches

Given the two records:
20, Saint Gerassimo Road, Petersfield, 7821865874
21, St. Grasimo Rd, Petterfeild, 7821868574
an any match without inferences will combine the results from the previous examples to give:

$$\begin{matrix}\begin{matrix}1 - ( 1 - 61 \% ) \times ( 1 - 86 \% ) \times \\ ( 1 - 66 \% ) \times ( 1 - 14 \% )\end{matrix} = 1 - 39 \% \times 14 \% \times 34 \% \times 86 \% \\ = 1 - 2 \% \\ = 98 \%\end{matrix}$$

The skilled addressee will appreciate the following advantages of the present invention:
The DPD generates matches between input record and a fraud database through comparing that input record with every record of the fraud database;
Each record match is given by one of a number of matching algorithms;
Each record match returns a value to indicate the probability of a match;
A matching algorithm may combine the results of one or more attached matching algorithms;
Field matching algorithms compare values found in the corresponding fields in the records to be compared; and
All operations are optimised by ceasing calculation as soon as a probability threshold is reached.

Modifications and variations may be made to the present invention without departing from the basic inventive concept. Modifications may include using alternative matching algorithms to the preferred ones described above. It is envisaged that the present invention may have application in areas outside of fraud detection, where it is desired to detect proximate data for other purposes. In this case instead of records of know cases of fraud, records known to meet a certain condition are used. When the probability of a match exceeds the threshold, the condition is considered to be met.

Alternative applications of the present invention could include an identity checker that for use in situations where the details of a person or company may be entered multiple times into a computer system and data entry anomalies can result. Normally this would create multiple entries with minor differences all relating to the same person. The present invention could be employed to identify that the data entered relates to the same person. Thus a single consistent set of data could be kept on a person. A further example may be where an applicant applies for a credit facility and the background of the applicant is to be checked. Quite innocently the details may be incorrectly entered. The present invention could be employed to detect whether the new data is similar to an existing record and if sufficiently close be regarded as matching an existing record. A skilled addressee will readily be able to identify other applications of the present invention and will be able to apply the invention to such other applications.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of detecting proximate data for use in fraud detection, the method comprising:
providing a database of records known to be fraudulent; and
checking a new record against each record in the database for a close match and in the event that a close match is found inferring that the new record is fraudulent;
wherein the checking comprises applying a matching algorithm to the new record and each record of the database so as to generate a probability of a match.

2. A method according to claim 1, further comprising determining that there is a close match in the event that the probability exceeds a threshold.

3. A method according to claim 2, wherein the probability is generated using field specific comparisons.

4. A method according to claim 2, wherein the probability is generated using aggregating comparisons.

5. A method according to claim 2, wherein the probability is generated using the combination of field specific comparisons and aggregating comparisons.

6. A data proximity detector, comprising:
a storage device configured to store a database of records determined as fraudulent;
a processor configured to check a new record against each record in the database retrieved from the storage device for a close match, wherein the processor is further configured to apply a matching algorithm to the new record and each record of the database so as to generate a probability of a match; and
an alert generator configured to indicate an inference that the new record is fraudulent in the event that the processor determines that there is a close match.

7. A method of detecting proximate data, comprising:
providing a database of records known to satisfy a condition; and
checking a new record against each record in the database for a close match and in the event that a close match is found inferring that the new record also satisfies the condition, wherein the checking comprises applying a matching algorithm to the new record and each record of the database so as to generate a probability of a match.

8. A data proximity detector, comprising:
a storage device configured to store a database of records known to satisfy a condition;
a processor configured to check a new record against each record in the database retrieved from the storage device for a close match, wherein the processor is further configured to apply a matching algorithm to the new record and each record of the database so as to generate a probability of a match; and
an alert generator configured to indicate an inference that the new record also satisfies the condition in the event that the processor determines that there is a close match.

9. A method according to claim 2, wherein the matching algorithm uses at least one of the following types of field matching: number matching, code matching, word matching and phrase matching.

10. A method according to claim 7, further comprising determining that the new record is potentially fraudulent if the probability exceeds a threshold.

11. A method of detecting proximate data for use in fraud detection, the method comprising:
receiving a new record;
comparing the new record with a previously stored record so as to generate a probability of a match, wherein the previously stored record includes fraudulent data; and
determining whether the new record is potentially fraudulent or not based on the probability.

12. A method according to claim 11, wherein the new record is determined to be potentially fraudulent if the probability exceeds a threshold.

13. A method according to claim 12, further comprising generating an alert signal if the new record is determined potentially fraudulent.

14. A method according to claim 11, wherein the comparison is made based on at least one of the following types of field matching: number matching, code matching, word matching and phrase matching.

15. A system for detecting proximate data for use in fraud detection, the system comprising:
means for receiving a new record;
means for comparing the new record with a previously stored record so as to generate a probability of a match, wherein the previously stored record includes fraudulent data; and
means for determining whether the new record is potentially fraudulent or not based on the probability.
